(19) United States
(12) Patent Application Publication
(10) Pub. No.: US 2024/0078748 A1
(43) Pub. Date: Mar. 7, 2024

(54) THREE-DIMENSIONAL RECONSTRUCTION DEVICE, THREE-DIMENSIONAL RECONSTRUCTION METHOD, AND RECORDING MEDIUM

(71) Applicant: Evident Corporation, Nagano (JP)

(72) Inventor: Naoyuki MIYASHITA, Tokorozawa-shi (JP)

(73) Assignee: Evident Corporation, Nagano (JP)

(21) Appl. No.: 18/387,185

(22) Filed: Nov. 6, 2023

Related U.S. Application Data
(63) Continuation of application No. PCT/JP2021/028000, filed on Jul. 29, 2021.

(51) Int. Cl. G06T 17/00; G06T 7/593

(52) U.S. Cl. CPC G06T 17/00; G06T 7/593

(57) ABSTRACT

A three-dimensional reconstruction device includes a processor. The processor is configured to acquire position-and-orientation information and two-dimensional coordinate information. The processor is configured to acquire a three-dimensional size of a subject. The processor is configured to calculate a correction coefficient used for matching the size at the position of a camera to a known size. The processor is configured to correct the position of the camera by using the correction coefficient. The processor is configured to restore a three-dimensional shape of the subject by using the corrected position. the orientation of the camera at the position, and the two-dimensional coordinate information.

### FIELD OF THE INVENTION

The present invention relates to a three-dimensional reconstruction device, a three-dimensional reconstruction method. and a recording medium.

The present application is a continuation application based on International Patent Application No. PCT/JP2021/28000 filed on Jul. 29, 2021, the content of which is incorporated herein by reference.

### DESCRIPTION OF RELATED ART

Inspection is performed in which an industrial endoscope that uses a technique called remote visual inspection (RV) acquires images of industrial products such as an aircraft engine or a pipe in a plant and the images are used. A probe used for acquiring images is inserted into a subject in the inspection. An optical adaptor, that is, an imaging optical system is disposed in the distal end of the probe. An inspector observes an image and determines whether there are defects or the like.

In general, an inspector observes the inside of a subject by using an image acquired through a monocular optical adaptor. It is important to correctly record the locations of defects or the like found in the subject during the inspection. However, it is difficult for the inspector to ascertain correct positions of defects or the like only from an image. Therefore, there is a demand for automatically determining the shape of a subject and the position (observation position) observed through an image.

A technique called structure-from-motion (SfM) or visual-simultaneous-localization-and-mapping (visual-SLAM) has been developed. This technique executes three-dimensional restoration (three-dimensional reconstruction) by using images acquired by a monocular camera. The shape of a subject and the observation position and orientation of the camera are restored through the three-dimensional restoration.

A phenomenon called scale drift occurs in principle in the three-dimensional restoration that uses images acquired by a monocular camera. The prior art provides loop-closing processing that resolves the scale drift. The prior art detects a loop when a camera goes around in a loop shape and returns to the same position as a previous position. The prior art corrects positions and orientations of the camera before and after the loop and corrects the entire tracks of the camera.

A technique disclosed in Japanese Unexamined Patent Application, First Publication No. 2017-167601 provides processing of reducing an error in estimating the position and the orientation of a camera. The technique increases the number of feature points detected from an image, thus reducing the error of estimation. Specifically, when the number of feature points is less than or equal to a threshold value, a moving direction and moving rate of the camera are changed.

### SUMMARY OF THE INVENTION

According to a first aspect of the present invention, a three-dimensional reconstruction device includes a processor configured to acquire position-and-orientation information and two-dimensional coordinate information. The position-and-orientation information indicates two or more different positions of a monocular camera and an orientation of the camera at each of the two or more positions. The two-dimensional coordinate information indicates two-dimensional coordinates of one or more points in each of two or more images of a subject acquired at the two or more positions by the camera. The position-and-orientation information and the two-dimensional coordinate information are generated through three-dimensional reconstruction processing that uses the two or more images. The processor is configured to: acquire a three-dimensional size of the subject at each of the two or more positions; calculate a correction coefficient used for matching the size at each of the two or more positions to a known size; correct each of the two or more positions by using the correction coefficient; and restore a three-dimensional shape of the subject by using the two or more corrected positions, the orientation at each of the two or more positions, and the two-dimensional coordinate information.

According to a second aspect of the present invention, in the first aspect, the processor may be configured to calculate the three-dimensional size of the subject at each of the two or more positions by using the position-and-orientation information.

According to a third aspect of the present invention, in the second aspect, the processor may be configured to: acquire shape information indicating a three-dimensional shape of the subject; and calculate, as the size, a depth of the three-dimensional shape indicated by the shape information of the subject captured in a field of view of the camera at each of the two or more positions.

According to a fourth aspect of the present invention, in the second aspect, the processor may be configured to calculate the size based on a distance between two positions included in the two or more positions.

According to a fifth aspect of the present invention, in the second aspect, the processor may be configured to: acquire shape information indicating a three-dimensional shape of the subject; and calculate the size by using a predetermined three-dimensional shape that approximates the three-dimensional shape indicated by the shape information.

According to a sixth aspect of the present invention, in the first aspect, the processor may be configured to acquire, from an input device, the size input into the input device.

According to a seventh aspect of the present invention, in the first aspect, the processor may be configured to calculate the correction coefficient by using both the size at each of the two or more positions and a target value of the size.

According to an eighth aspect of the present invention, a three-dimensional reconstruction method includes acquiring, by a processor, position-and-orientation information and two-dimensional coordinate information. The position-and-orientation information indicates two or more different positions of a monocular camera and an orientation of the camera at each of the two or more positions. The two-dimensional coordinate information indicates two-dimensional coordinates of one or more points in each of two or more images of a subject acquired at the two or more positions by the camera. The position—and-orientation information and the two—dimensional coordinate information are generated through three-dimensional reconstruction processing that uses the two or more images. The method includes: acquiring, by the processor, a three-dimensional size of the subject at each of the two or more positions; calculating, by the processor, a correction coefficient used for matching the size at each of the two or more positions to a known size; correcting, by the processor, each of the two or more positions by using the correction coefficient; and restoring, by the processor, a three-dimensional shape of the subject by using the two or more corrected positions, the orientation at each of the two or more positions, and the two-dimensional coordinate information.

According to a ninth aspect of the present invention, a non-transitory computer-readable recording medium saves a program causing a computer to execute acquiring position-and-orientation information and two-dimensional coordinate information. The position-and-orientation information indicates two or more different positions of a monocular camera and an orientation of the camera at each of the two or more positions. The two-dimensional coordinate information indicates two-dimensional coordinates of one or more points in each of two or more images of a subject acquired at the two or more positions by the camera. The position-and-orientation information and the two-dimensional coordinate information are generated through three-dimensional reconstruction processing that uses the two or more images. The program causes the computer to execute: acquiring a three-dimensional size of the subject at each of the two or more positions; calculating a correction coefficient used for matching the size at each of the two or more positions to a known size; correcting each of the two or more positions by using the correction coefficient; and restoring a three-dimensional shape of the subject by using the two or more corrected positions, the orientation at each of the two or more positions, and the two—dimensional coordinate information.

### BRIEF DESCRIPTION OF THE DRAWINGS

FIG. 1 is a block diagram showing a configuration of a three-dimensional (3D) reconstruction device according to a first embodiment of the present invention.

FIG. 2 is a flow chart showing a procedure of processing executed by the 3D reconstruction device according to the first embodiment of the present invention.

FIG. 3 is a diagram showing a position of a camera and a 3D shape of a subject in the first embodiment of the present invention.

FIG. 4 is a diagram showing an example of the size of a subject in the first embodiment of the present invention,

FIG. 5 is a diagram showing an example of the size of a subject in the first embodiment of the present invention.

FIG. 6 is a graph of the depth in the first embodiment of the present invention.

FIG. 7 is a graph of a baseline length in the first embodiment of the present invention.

FIG. 8 is a graph of a ratio between a predetermined size and the size at a camera position in the first embodiment of the present invention.

FIG. 9 is a graph of a correction coefficient in the first embodiment of the present invention.

FIG. 10 is a graph of a corrected position of a camera in the first embodiment of the present invention.

FIG. 11 is a diagram showing an example of a 3D shape restored by the 3D reconstruction device according to the first embodiment of the present invention.

FIG. 12 is a diagram showing an example of a 3D shape restored by the 3D reconstruction device according to the first embodiment of the present invention.

FIG. 13 is a diagram showing an example of a subject in the first embodiment of the present invention.

FIG. 14 is a diagram showing an example of a 3D shape indicated by shape information input into the 3D reconstruction device according to the first embodiment of the present invention.

FIG. 15 is a diagram showing an example of a 3D shape restored by the 3D reconstruction device according to the first embodiment of the present invention.

FIG. 16 is a block diagram showing a configuration of a 31) reconstruction device according to a second embodiment of the present invention.

FIG. 17 is a flow chart showing a procedure of processing executed by the 31) reconstruction device according to the second embodiment of the present invention.

FIG. 18 is a diagram showing an example of a subject in the second embodiment of the present invention.

FIG. 19 is a diagram showing an example of a 3D shape restored by the 3D reconstruction device according to the second embodiment of the present invention.

### DETAILED DESCRIPTION OF THE INVENTION

Hereinafter, embodiments of the present invention will be described with reference to the drawings.

### First Embodiment

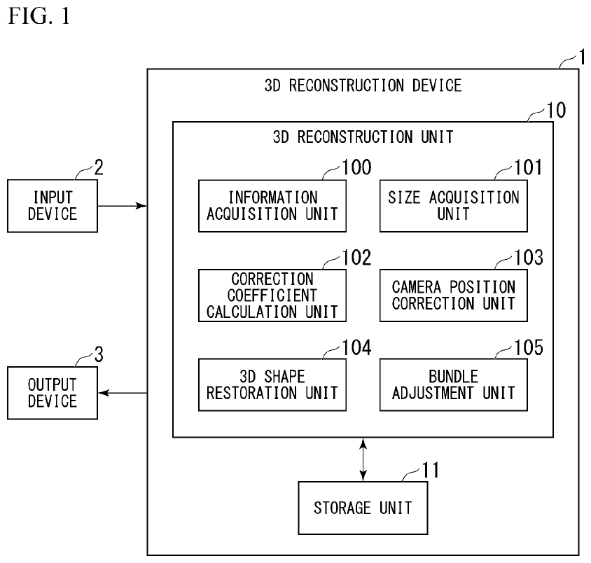

FIG. 1 shows a configuration of a 3D reconstruction device 1 according to a first embodiment of the present invention. The 3D reconstruction device 1 shown in FIG. 1 includes a 3D reconstruction unit 10 and a storage unit 11. The 3D reconstruction unit 10 includes an information acquisition unit 100, a size acquisition unit 101, a correction coefficient calculation unit 102, a camera position correction unit 103, a 3D shape restoration unit 104, and a bundle adjustment unit 105.

A schematic configuration of the 3D reconstruction device 1 will be described. The information acquisition unit 100 acquires position-and-orientation information and two-dimensional coordinate information (21) coordinate information). The position-and-orientation information indicates two or more different positions of a monocular camera and an orientation of the camera at each of the two or more positions. The 2D coordinate information indicates two-dimensional coordinates (2D coordinates) of one or more points in each of two or more images of a subject acquired at the two or more positions by the camera. The position-and-orientation information and the 2D coordinate information are generated through three-dimensional reconstruction processing (3D reconstruction processing) that uses the two or more images. The size acquisition unit 101 acquires a three-dimensional size of the subject at each of the two or more positions of the camera. The correction coefficient calculation unit 102 calculates a correction coefficient used for matching the size at each of the two or more positions to a known size. The camera position correction unit 103 corrects each of the two or more positions of the camera by using the correction coefficient. The 3D shape restoration unit 104 restores a three-dimensional shape (3D shape) of the subject by using the two or more positions corrected by the camera position correction unit 103, the orientation of the camera at each of the two or more positions, and the 2D coordinate information.

The above-described camera includes a monocular imaging optical system corresponding to one viewpoint. The camera captures an optical image of the subject seen from the viewpoint and generates an image based on the optical image. Hereinafter, the position of the camera corresponding to the viewpoint will be called a camera position.

A detailed configuration of the 3D reconstruction device 1 will be described. The 3D reconstruction device 1 is connected to an input device 2 and an output device 3. The 3D reconstruction device 1 may include at least one of the input device 2 and the output device 3.

The input device 2 inputs position-and-orientation information, shape information, 2D coordinate information, and the like into the 3D reconstruction device 1. For example, the input device 2 includes a communicator that performs communication with an external device, and receives the position-and-orientation information, the shape information, and the 2D coordinate information from the external device. The input device 2 may include a reading circuit that reads the position-and-orientation information, the shape information, and the 2D coordinate information from an external storage medium. The input device 2 may include a user interface. For example, the user interface is a button, a switch, a key, a mouse, a joystick, a touch pad, a track ball, or a touch panel. A user may input information into the input device 2 through the user interface.

The position-and-orientation information, the shape information, and the 2D coordinate information are generated through 3D reconstruction processing that uses SfM. visual-SLAM or the like. Two or more images (key frames) of a subject are used in the 3D reconstruction processing. The camera acquires images at two or more different camera positions.

The position-and-orientation information includes three-dimensional coordinates (3D coordinates) of each of the two or more camera positions and orientation information indicating the orientation of the camera at each of the two or more camera positions. A camera position is expressed by a three-dimensional vector (x, y, z) indicating a position in three-dimensional space. The orientation of the camera is expressed by a three-dimensional vector (rx, ry, rz) or a rotation matrix of 3×3 indicating a rotation amount around an axis. The position-and-orientation information is information of the sum of 6 degrees of freedom (DoF) described above. One camera position and one orientation are associated with each other. Two orientations of the camera may be the same or different between two different camera positions.

The shape information indicates a 3D shape of a subject. The shape information is a three-dimensional point cloud of the subject. The shape information includes 3D coordinates of each of three or more positions on the subject. The 3D coordinates and the orientation information in the position-and-orientation information are associated with the 3D coordinates in the shape information. In other words, the position and orientation of the camera are associated with a point on the 3D shape of the subject.

The 2D coordinate information indicates 2D coordinates of one or more points in each of two or more images (key frames) of a subject. The 3D coordinates of each point in the shape information are associated with the 2D coordinates of the 2D coordinate information corresponding to each point in the shape information.

The output device 3 outputs a 3D shape of a subject restored by the 3D reconstruction device 1. For example, the output device 3 outputs an image of the 3D shape to a display. The output device 3 may include a communicator that performs communication with an external device, and may transmit the 3D shape to the external device. The output device 3 may include a writing circuit that writes the 3D shape on an external storage medium.

The information acquisition unit 100 acquires, from the input device 2, the position-and-orientation information, the shape information, and the 2D coordinate information input by the input device 2.

The size acquisition unit 101 acquires a three-dimensional size of a subject at each camera position. For example, the size acquisition unit 101 calculates the size by using at least one of the position-and-orientation information and the shape information. The input device 2 may input a known size into the 3D reconstruction device 1. The size acquisition unit 101 may acquire, from the input device 2, the size input by the input device 2. Details of the size of the subject will be described later.

The correction coefficient calculation unit 102 calculates a correction coefficient used for matching the size in the 3D shape indicated by the shape information input into the 3D reconstruction device 1 to a predetermined size. The camera position correction unit 103 corrects each of the two or more camera positions by using the correction coefficient calculated by the correction coefficient calculation unit 102.

The 3D shape restoration unit 104 executes triangulation and restores a 3D shape of a subject. At this time, the 3D shape restoration unit 104 uses the two or more camera positions corrected by the camera position correction unit 103. In addition, the 3D shape restoration unit 104 uses the orientation associated with each of the two or more camera positions. Furthermore, the 3D shape restoration unit 104 uses the 2D coordinate information. The 3D shape restoration unit 104 generates shape information including 3D coordinates of each of three or more positions on the subject through this processing. Typical processing used in the 3D reconstruction may be used in the triangulation.

The bundle adjustment unit 105 executes bundle adjustment for stabilizing a 3D shape of a subject. At this time, the shape information generated by the 3D shape restoration unit 104 is processed. Typical processing of optimizing the position and orientation of the camera and the 3D coordinates may be used in the bundle adjustment so as to minimize a reprojection error of a 3D point.

The 3D reconstruction unit 10 may be constituted by at least one of a processor and a logic circuit. For example, the processor is at least one of a central processing unit (CPU), a digital signal processor (DSP), and a graphics-processing unit (GPU). For example, the logic circuit is at least one of an application-specific integrated circuit (ASIC) and a field-programmable gate array (FPGA). The 3D reconstruction unit 10 may include one or a plurality of processors. The 3D reconstruction unit 10 may include one or a plurality of logic circuits.

A computer of the 3D reconstruction device 1 may read a program and execute the read program. The program includes commands defining the operations of the 3D reconstruction unit 10. In other words, the functions of the 3D reconstruction unit 10 may be realized by software.

The program described above, for example, may be provided by using a “computer-readable storage medium” such as a flash memory. The program may be transmitted from the computer storing the program to the 3D reconstruction device 1 through a transmission medium or transmission waves in a transmission medium. The “transmission medium” transmitting the program is a medium having a function of transmitting information. The medium having the function of transmitting information includes a network (communication network) such as the Internet and a communication circuit line (communication line) such as a telephone line. The program described above may realize some of the functions described above. In addition, the program described above may be a differential file (differential program). The functions described above may be realized by a combination of a program that has already been recorded in a computer and a differential program.

The storage unit 11 stores the position-and-orientation information, the shape information, and the 213 coordinate information acquired by the information acquisition unit 100. In addition, the storage unit 11 stores the shape information processed by the bundle adjustment unit 105.

The storage unit 11 is a volatile or nonvolatile recording medium. For example, the storage unit 11 is at least one of a random-access memory (RAM). a dynamic random-access memory (DRAM), a static random-access memory (SRAM), an erasable programmable read-only memory (DRAM), an electrically erasable programmable read-only memory (EEPROM), and a flash memory.

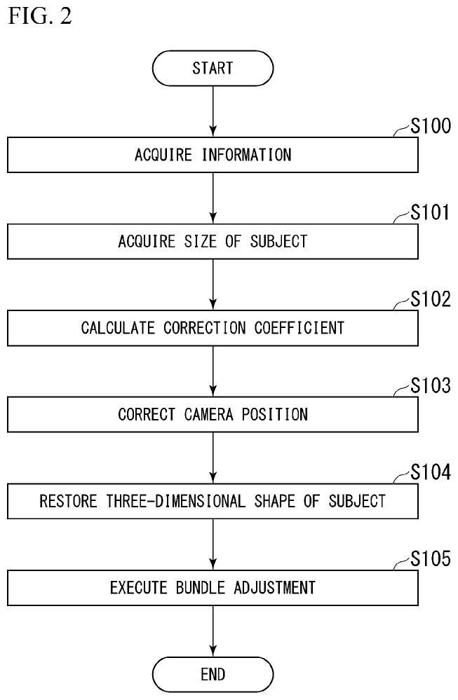

Processing executed by the 3D reconstruction device 1 will be described. FIG. 2 shows a procedure of the processing executed by the 3D reconstruction device 1.

The information acquisition unit 100 acquires, from the input device 2, the position-and-orientation information, the shape information, and the 21) coordinate information input by the input device 2 (Step S100). The position-and-orientation information, the shape information, and the 2D coordinate information acquired by the information acquisition unit 100 are stored on the storage unit 11. Each unit of the 3D reconstruction unit 10 reads the position-and-orientation information, the shape information, or the 2D coordinate information from the storage unit 11 and processes the read information.

After Step S100, the size acquisition unit 101 acquires the size of a subject (Step S101).

The size acquisition unit 101 executes the following processing in Step S101. Hereinafter, an example in which the size acquisition unit 101 calculates the size of the subject will be described.

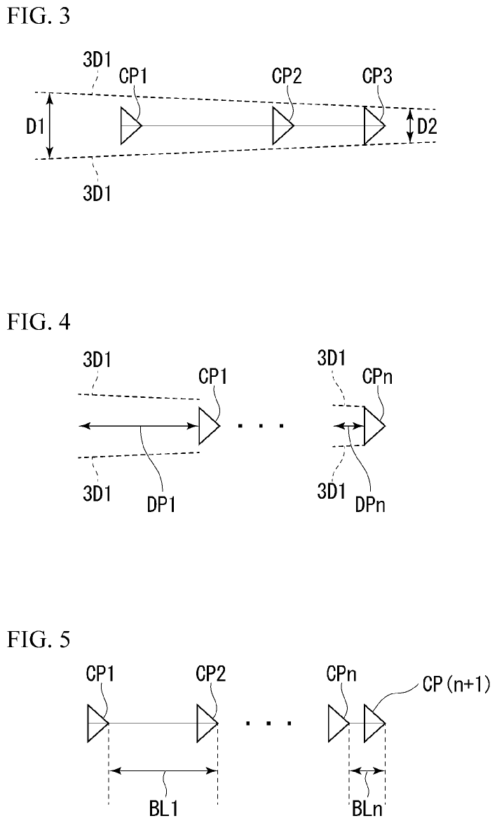

FIG. 3 shows an example of acquiring from the information acquisition unit 100 results of monocular 3D reconstruction performed in advance on a video image acquired by recording the inside of a subject that is a pipe having a fixed inner diameter by using an endoscope. A 3D shape 3D1 is a 3D point cloud of a subject indicated by the shape information. Each of camera positions CP1, CP2, and CP3 indicates a camera position of an image (a so-called key frame) that is included in the video image and is used in the 3D reconstruction.

In a subject that is a pipe having a fixed inner diameter, an inner diameter indicated by the subject's 3D shape should be ideally fixed. However, the 3D shape changes because scale drift occurs in the monocular 3D reconstruction. FIG. 3 shows an example in which the scale drift occurs as reduction of an inner diameter. For example, the scale drift occurs as the difference between an inner diameter 1 and an inner diameter D2.

There is a case in which scale drift not only occurs as reduction but also occurs as expansion or a combination of expansion and reduction. Hereinafter, each embodiment of the present invention will be described assuming that only reduction occurs in order to simplify the descriptions.

FIG. 4 and FIG. 5 show examples of the size of a subject. A camera position CP1 and a camera position CPn are shown in FIG. 4. A camera position between the camera position CP1 and the camera position (Pn is not shown in FIG. 4. The size acquisition unit 101 calculates a depth DP1 and a depth DPn shown in FIG. 4 by using the position-and-orientation information and the shape information. The depth DP1 indicates the depth of the subject seen from the camera position CP1. The depth DPn indicates the depth of the subject seen from the camera position CPn. The size acquisition unit 101 calculates the depth at each camera position between the camera position CP1 and the camera position CPn in addition to the depth DP1 and the depth DPn.

The coordinate system of the camera is defined by an X axis, a Y axis, and a Z axis. The X axis and the Y axis are parallel to the image plane of the camera. The Z axis is perpendicular to the image plane. For example, the size acquisition unit 101 extracts 3D coordinates associated with each camera position from the shape information. The coordinate system in the shape information is a predetermined world coordinate system. The origin of the coordinate system in the shape information is, for example, the 0th camera position when the 3D reconstruction is executed. The size acquisition unit 101 converts the coordinate system of the 3D coordinates constituting the shape information into a coordinate system of which reference is the camera by using a camera position in the position-and-orientation information and the orientation information. Thereafter, the size acquisition unit 101 calculates the depth by using a Z coordinate of the converted 3D coordinates. The depth is calculated by using, for example, a median of a plurality of Z coordinates.

A camera position CP1, a camera position CP2, a camera position CPn, and camera position CP(n+1) are shown in FIG. 5. A camera position between the camera position CP2 and the camera position CPn is not shown in FIG. 5. The size acquisition unit 101 calculates a baseline length BL1 and a baseline length BLn shown in FIG. 5 by using the position-and-orientation information. The baseline length BL1 indicates a shift of the camera from the camera position CP1 to the camera position CP2, that is, a three-dimensional distance between the camera position CP1 and the camera position CP2. The baseline length BLn indicates a shift of the camera from the camera position CPn to the camera position CP(n+1), that is, a three-dimensional distance between the camera position CPn and the camera position CP(n+1). The size acquisition unit 101 calculates a baseline length related to each camera position between the camera position CP2 and the camera position CPn in addition to the baseline length BL1 and the baseline length BLn.

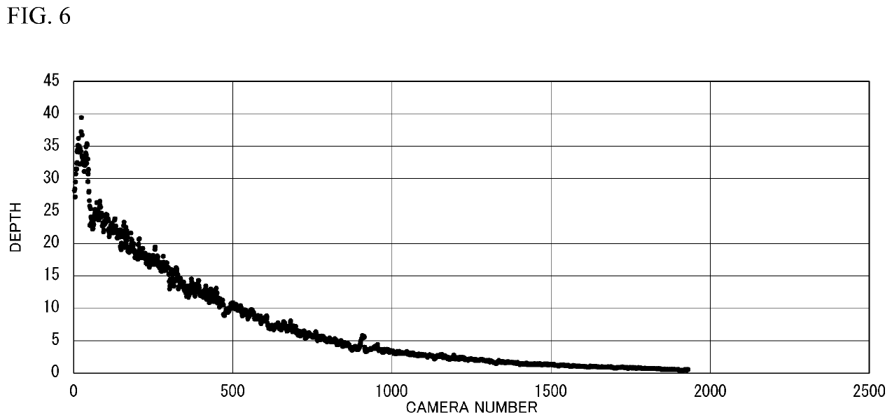

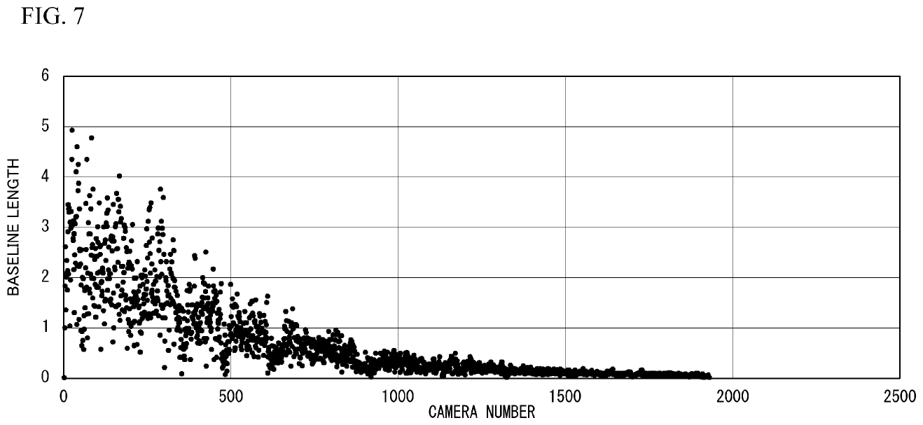

FIG. 6 shows an example of the depth calculated by the size acquisition unit 101. The horizontal axis in FIG. 6 indicates a camera number corresponding to a camera position. The vertical x is in FIG. 6 indicates the depth. The camera number corresponds to the distance from a reference position. For example, the reference position is a position of a camera having the first camera number. The depth decreases as the distance from the reference position increases.

FIG. 7 shows an example of the baseline length calculated by the size acquisition unit 101. The horizontal axis in FIG. 7 indicates a camera number corresponding to a camera position similarly to FIG. 6. The vertical axis in FIG. 7 indicates a baseline length.

The size acquisition unit 101 may calculate an inner diameter of the 3D shape 3D1 shown in FIG. 3 as the size of a subject. The size acquisition unit 101 executes, for example, fitting processing of fitting an existing cylindrical shape to a 3D shape (3D point cloud) near the camera position CP1 and thereby can calculate an inner diameter at the camera position CP1. The size acquisition unit 101 may calculate the size of a subject by executing point cloud registration or the like that uses the 3D shape 3D1 and a predetermined 3D shape.

As described above, the size of a subject is an index indicating the degree of scale drift and can be transformed into various indices by using a method following an objective.

When the size of a subject is known, a user may input the size into the 3D reconstruction device 1 via the user interface included in the input device 2. For example, the user may input an inner diameter of the subject into the 3D reconstruction device 1. The size acquisition unit 101 may acquire, from the input device 2, the size input by the input device 2.

The size acquisition unit 101 acquires the size at each of two or more camera positions. In other words, the size acquisition unit 101 acquires two or more sizes. The size acquisition unit 101 need not acquire sizes at all the camera positions. The size acquisition unit 101 may acquire only the size at the first camera position and the size at the last camera position.

After Step S101, the correction coefficient calculation unit 102 calculates a correction coefficient based on the size at each camera position and a known size (Step S102).

The correction coefficient calculation unit 102 executes the following processing in Step S102. For example, the correction coefficient calculation unit 102 calculates a ratio (St/Si) of a predetermined size St to a size Si at a camera position i. The correction coefficient calculation unit 102 levels the ratios (St/Si) at the two or more camera positions. Various methods can be used as a method of leveling. For example, the correction coefficient calculation unit 102 calculates an average value of ratios (St/Si) at all the camera positions in a section that includes the camera position i and has a predetermined length. The correction coefficient calculation unit 102 handles the calculated average value as a correction coefficient at the camera position i. The correction coefficient calculation unit 102 levels the ratios (St/Si) related to the size of a subject at the two or more camera positions and thereby can restrict an influence of noise.

The predetermined size St indicates a target value of the size of a subject. The position-and-orientation information and shape information generated through the 3D reconstruction processing do not have units of absolute size. Therefore, the size St has only to be a greater value than 0 and may be set to any value in a range in which calculation does not fail. A relative distance in the 3D shape restored by the 3D shape restoration unit 104 changes in accordance with the size St. However, the size St does not affect correction of the entire 3D shape.

The correction coefficient calculation unit 102 may calculate a median or the like instead of an average value. The correction coefficient calculation unit 102 may calculate the ratio (St/Si) by using a polynomial. The correction coefficient calculation unit 102 may calculate a correction coefficient at each camera position by using the polynomial.

The storage unit 11 may store a table that stores a parameter used for calculating a correction coefficient. The correction coefficient calculation unit 102 may calculate each correction coefficient by using the table.

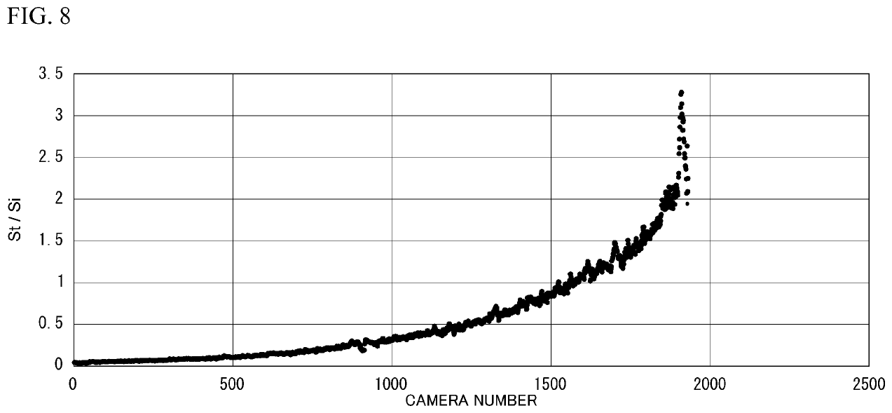

FIG. 8 shows an example of the ratio (St/Si) calculated by the correction coefficient calculation unit 102. The horizontal axis in FIG. 8 indicates a camera number corresponding to a camera position. The vertical axis in FIG. 8 indicates the ratio (St/Si).

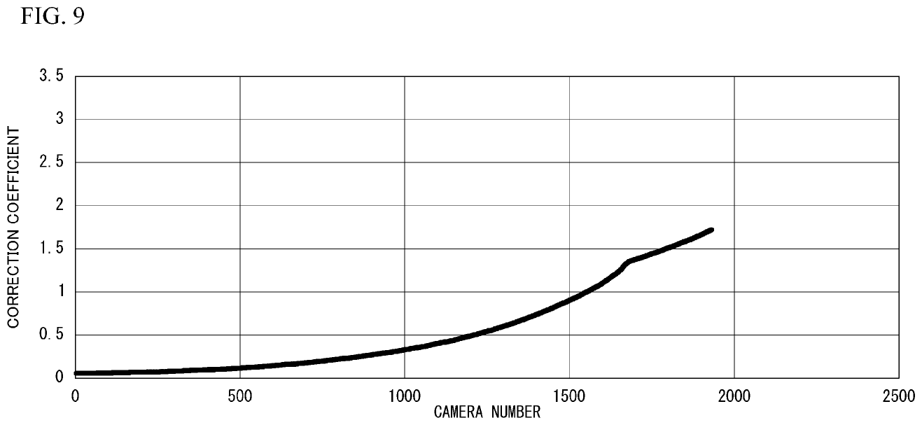

FIG. 9 shows an example of the correction coefficient calculated by the correction coefficient calculation unit 102. The horizontal axis in FIG. 9 indicates a camera number corresponding to a camera position. The vertical axis in FIG. 9 indicates the correction coefficient. In FIG. 6 and FIG. 7, the size of a subject decreases as the distance from the reference position increases. In FIG. 9, the correction coefficient increases as the distance from the reference position increases. In other words, the correction coefficient increases as the size of the subject decreases.

After Step S102, the camera position correction unit 103 corrects each of the two or more camera positions by using the correction coefficient calculated by the correction coefficient calculation unit 102 (Step S103).

The camera position correction unit 103 executes the following processing in Step S103. For example, the camera position correction unit 103 corrects each camera position by using the following Expression (1).

Ocᵢ=Cᵢ(Oᵢ−Oᵢ₋₁)+Ocᵢ₋₁ (1)

A camera position Ocᵢ and a camera position Ocᵢ₋₁ in Expression (1) indicate camera positions (coordinates of a camera center) that have been corrected. A camera position Oᵢ and a camera position Oᵢ₋₁ in Expression (1) indicate camera positions (coordinates of a camera center) that have not been corrected. A value Cᵢ in Expression (1) indicates the correction coefficient calculated in Step S102. The first term (Cᵢ(Oᵢ−Oᵢ₋₁)) of the right side of Expression (1) is obtained by multiplying the baseline length of the camera with the correction coefficient.

In Expression ( ), the distance between two camera positions is corrected in accordance with the correction coefficient. The corrected camera position Ocᵢ is calculated by adding the corrected distance to the camera position Ocᵢ₋₁.

The camera position Oᵢ is the reference position and is not corrected. When a camera position Oc₂ is calculated, the camera position Oᵢ is used instead of the camera position Ocᵢ₋₁ in Expression (1).

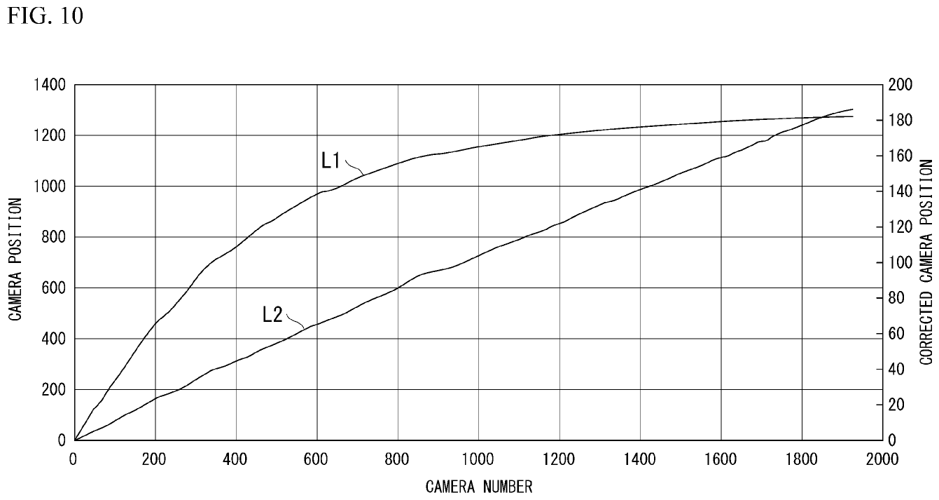

FIG. 10 shows an example of the corrected camera position. The horizontal axis in FIG. 10 indicates a camera number corresponding to a camera position. The left vertical axis in FIG. 10 indicates a camera position that has not been corrected. The right vertical axis in FIG. 10 indicates a camera position that has been corrected. Each camera position is shown as the distance from the reference position to the camera. A line L1 shows a graph of the camera position that has not been corrected. A line L2 shows a graph of the camera position that has been corrected. Before each camera position is corrected, a change of the camera position gradually decreases along with an increase of the camera number as the line L1 shows. After each camera position is corrected, a relationship between the camera number and the camera position is almost linear as the line L2 shows. in other words, an influence of scale drift is restricted.

After Step S103, the 3D shape restoration unit 104 executes triangulation and restores a 3D shape of a subject (Step S104).

The 3D shape restoration unit 104 executes the following processing in Step S104. The 3D shape restoration unit 104 calculates 3D coordinates of each of three or more positions on the subject by using the two or more corrected camera positions, orientations associated with the two or more camera positions, and the 2D coordinate information. The 3D shape restoration unit 104 can use processing executed in typical 3D reconstruction processing that uses an image acquired by a monocular camera. The 3D shape restoration unit 104 generates shape information including the calculated 3D coordinates.

After Step S104, the bundle adjustment unit 105 executes the bundle adjustment that uses the shape information generated by the 3D shape restoration unit 104 (Step S105). When Step S105 is executed, the processing shown in FIG. 2 is completed.

The bundle adjustment unit 105 can use typical bundle adjustment. However, the bundle adjustment is not always required. Accordingly, Step S105 may be omitted.

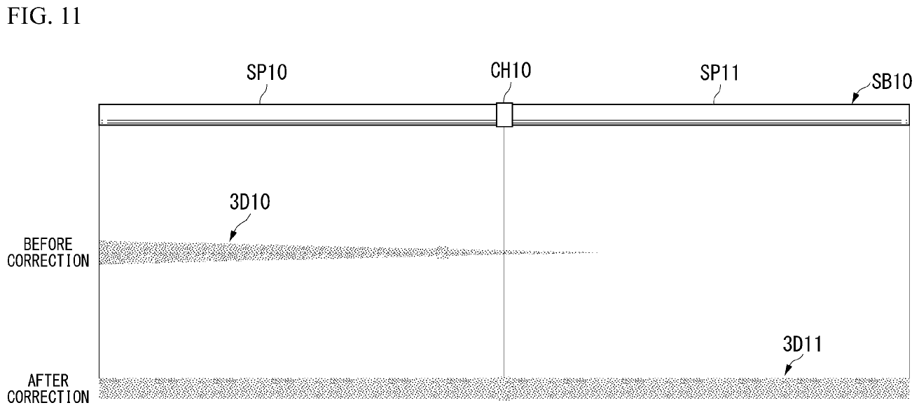

FIG. 11 shows an example of the 3D shape restored by the 3D reconstruction device 1. A subject SB10 shown in FIG. 11 is a pipe. The subject SB10 includes a straight part SP10, a straight part SP11, and a tee CH10 (fitting). The tee CH10 is disposed between the straight part SP10 and the straight part SP11. The camera moves from the left end of the straight part SP10 toward the right end of the straight part SP11.

A 3D shape 3D10 in FIG. 11 is indicated by the shape information input into the 3D reconstruction device 1. In other words, the 3D shape 3D10 is restored by using camera positions that have not been corrected by the camera position correction unit 103.

A 3D shape 3D11 in FIG. 11 is indicated by the shape information generated by the 3D shape restoration unit 104. In other words, the 3D shape 3D01 is restored by using camera positions that have been corrected by the camera position correction unit 103.

The 3D shape 3D10 gradually becomes thinner and shorter from the left side toward the right side. The length of the 3D shape 3D10 is greatly different from that of the subject SB10. On the other hand, changes of the length and thickness of the 3D shape 3D11 are considerably restricted.

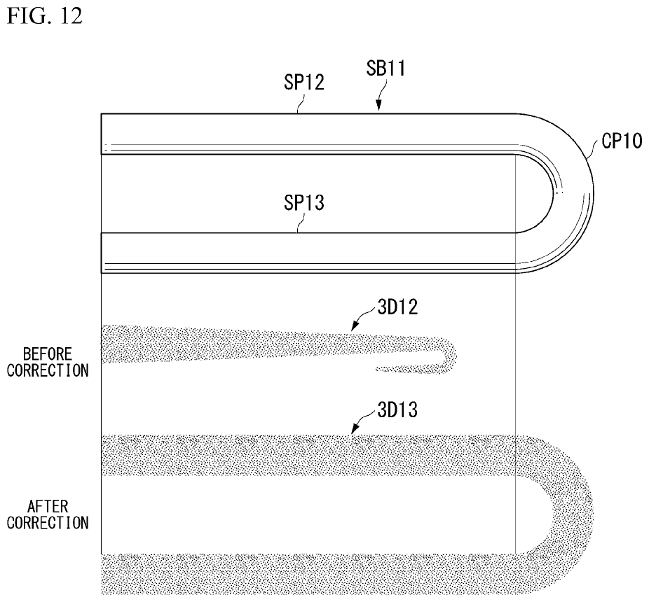

FIG. 12 shows another example of the 3D shape restored by the 3D reconstruction device 1. A subject SB11 shown in FIG. 12 is a U-shaped pipe. The subject SB11 includes a straight part SP12, a straight part SP13, and a curved part CP10. The curved part CP10 is disposed between the straight part SP12 and the straight part SP13. The inner diameter of the curved part CP10 is the same as that of each of the straight parts SP12 and SP13. The camera moves from the left end of the straight part SP12 toward the left end of the straight part SP13.

A 3D shape 3D12 in FIG. 12 is indicated by the shape information input into the 3D reconstruction device 1. In other words, the 3D shape 3D12 is restored by using camera positions that have not been corrected by the camera position correction unit 103.

A 3D shape 3D13 in FIG. 12 is indicated by the shape information generated by the 3D shape restoration unit 104. In other words, the 3D shape 3D13 is restored by using camera positions that have been corrected by the camera position correction unit 103.

The 3D shape 3D12 gradually becomes thinner and shorter from the left end of the straight part SP12 toward the left end of the straight part SP13. The length of the 3D shape 3D12 is greatly different from that of the subject S1311. On the other hand, changes of the length and thickness of the 3D shape 3D13 are considerably restricted.

A subject in the first embodiment may be a T-shaped pipe. Even when the subject is the T-shaped pipe, a change of the size of the 3D shape of the subject is considerably restricted.

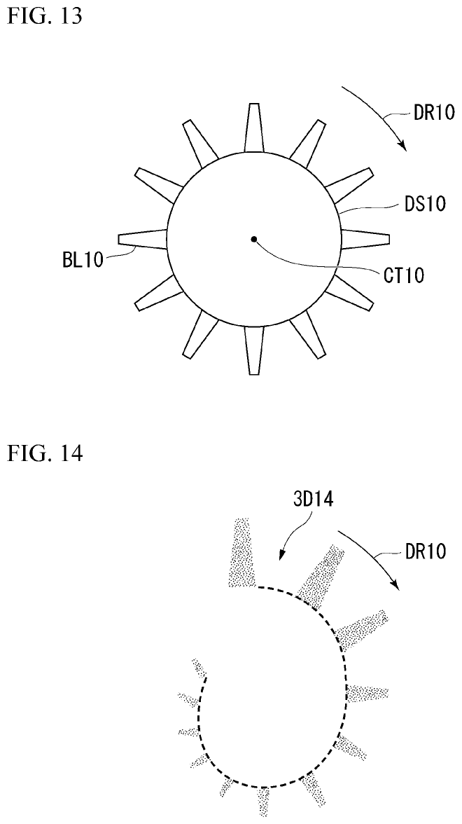

Other examples of the 3D shape restored by the 3D reconstruction device 1 will be described. Subjects in the following examples are blades disposed in a gas turbine of an aircraft engine. The gas turbine includes two or more blades. FIG. 13 schematically shows a configuration of the blades. The two or more blades are circularly and radially fixed to a discoid component called a disk. In FIG. 13, twelve blades BL10 are disposed in a disk DS10. A center position CT10 indicates the center of the disk DS10 in a perpendicular plane to a rotation axis of an engine. The position of the camera is fixed, and the disk DS10 rotates in a reverse direction to a direction DR11. Therefore, the camera relatively moves in the direction DR10.

A 3D shape 3D14 in FIG. 14 is indicated by the shape information input into the 3D reconstruction device 1. In other words, the 3D shape 3D14 is restored by using camera positions that have not been corrected by the camera position correction unit 103.

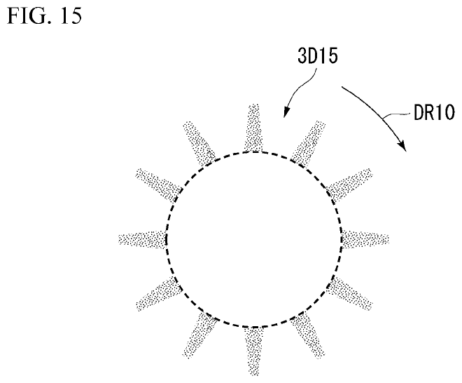

A 3D shape 3D15 in FIG. 15 is indicated by the shape information generated by the 3D shape restoration unit 104. In other words, the 3D shape 3D15 is restored by using camera positions that have been corrected by the camera position correction unit 103.

The 3D shape 3D14 gradually becomes thinner and shorter along the direction DR10. On the other hand, changes of the length and thickness of the 3D shape 3D15 in the direction DR10 are considerably restricted.

A three-dimensional reconstruction method according to each aspect of the present invention includes an information acquisition step, a size acquisition step, a correction coefficient calculation step, a camera position correction step, and a three-dimensional shape restoration step. The information acquisition unit 100 acquires the position-and-orientation information and the 2D coordinate information in the information acquisition step (Step S100). The size acquisition unit 101 acquires a three-dimensional size of a subject at each of two or more positions of a camera in the size acquisition step (Step S101). The correction coefficient calculation unit 102 calculates a correction coefficient used for matching the size at each of the two or more positions to a known size in the correction coefficient calculation step (Step S102). The camera position correction unit 103 corrects each of the two or more positions of the camera by using the correction coefficient in the camera position correction step (Step S103). The 3D shape restoration unit 104 restores a 3D shape of the subject by using the two or more corrected positions, the orientation of the camera at each of the two or more positions, and the 2D coordinate information in the three-dimensional shape restoration step (Step S104.

Each aspect of the present invention may include the following modified example. The size acquisition unit 101 calculates the three-dimensional size of the subject at each of the two or more positions of the camera by using the position-and-orientation information.

Each aspect of the present invention may include the following modified example. The information acquisition unit 100 acquires shape information indicating the 3D shape of the subject. The size acquisition unit 101 calculates, as the size of the subject, the depth of the 3D shape indicated by the shape information of the subject captured in a field of view of the camera at each of the two or more positions of the camera.

Each aspect of the present invention may include the following modified example. The size acquisition unit 101 calculates the size of the subject based on the distance between two positions included in the two or more positions of the camera.

Each aspect of the present invention may include the following modified example. The size acquisition unit 101 acquires, from the input device 2, the size input into the input device 2.

Each aspect of the present invention may include the following modified example. The correction coefficient calculation unit 102 calculates the correction coefficient by using both the size of the subject at each of the two or more positions of the camera and a target value of the size of the subject.

Each aspect of the present invention may include the following modified example. The correction coefficient calculation unit 102 levels values related to the size of the subject at the two or more positions of the camera. The correction coefficient calculation unit 102 calculates the correction coefficient by using the leveled values.

In the first embodiment, the correction coefficient calculation unit 102 calculates the correction coefficient to match the size in the 3D shape of the subject to a known size. The camera position correction unit 103 corrects each of the two or more camera positions by using the correction coefficient. The 3D shape restoration unit 104 restores the 3D shape of the subject by using the two or more corrected camera positions and the orientation of the camera at each camera position, By doing this, the 3D reconstruction device 1 can reduce an error of the 3D shape of the subject.

In the first embodiment, examples in which scale drift occurs only as a reduction are shown in order to simplify the descriptions. However, it is needless to say that the above-described methods can be widely applied to results of the 3D reconstruction in a case in which the expansion, a combination of the expansion and the reduction, or the like occurs and execution of the 3D reconstruction causes the size of the subject to be different from an original size.

### Second Embodiment

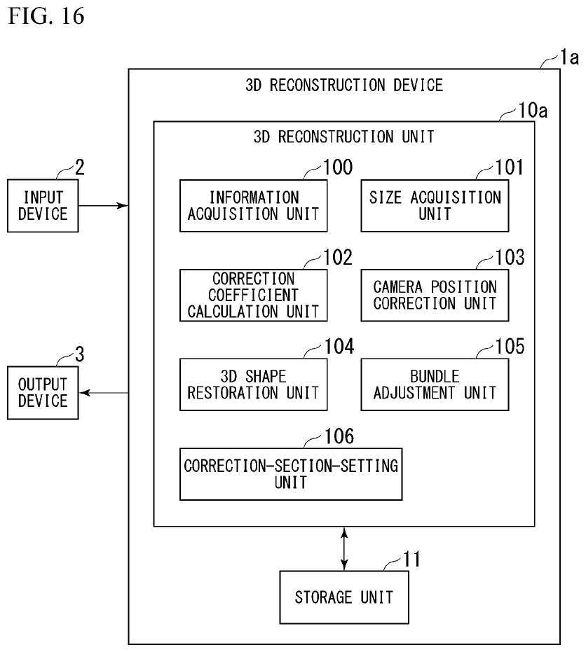

A second embodiment of the present invention will be described. FIG. 16 shows a configuration of a 3D reconstruction device 1a according to a second embodiment of the present invention. The 3D reconstruction device 1a shown in FIG. 16 includes a 3D reconstruction unit 10a and a storage unit 11. The 3D reconstruction unit 10a includes an information acquisition unit 100, a size acquisition unit 101, a correction coefficient calculation unit 102, a camera position correction unit 103, a 3D shape restoration unit 104, a bundle adjustment unit 105, and a correction-section-setting unit 106. The same configurations as those shown in FIG. 1 will not be described.

The correction-section-setting unit 106 sets two or more correction sections on the 3D shape of the subject indicated by the shape information acquired by the information acquisition unit 100. The correction coefficient calculation unit 102 calculates a correction coefficient for each correction section.

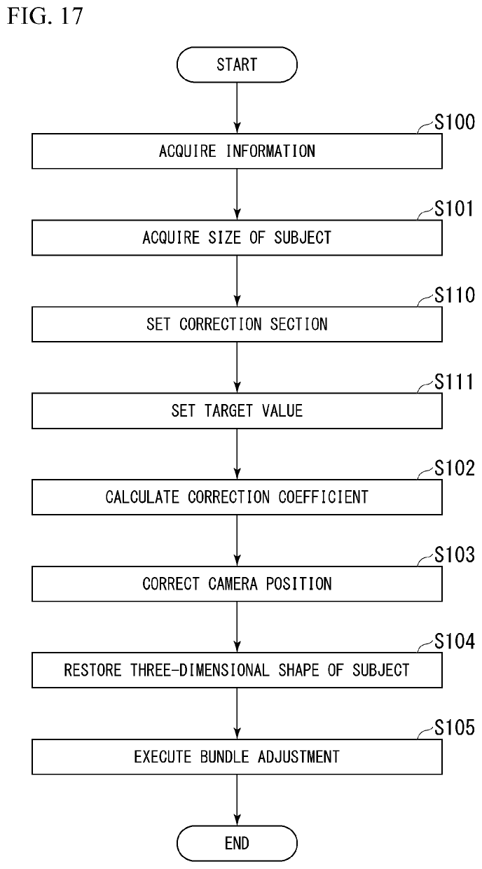

Processing executed by the 3D reconstruction device Ia will be described. FIG. 17 shows a procedure of the processing executed by the 3D reconstruction device 1a. The same processing as that shown in FIG. 2 will not be described.

After Step S101, the correction-section-setting unit 106 sets two or more correction sections on the 3D shape of the subject (Step S110).

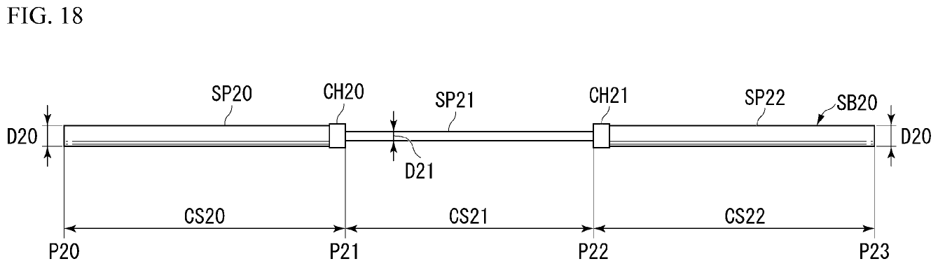

FIG. 18 shows an example of the subject. A subject SB20 shown in FIG. 18 is a pipe having different diameters. The pipe having different diameters has a structure in which two or more pipes having different diameters are connected. The subject SB20 includes a straight part SP20, a straight part SP21, a straight part SP22, a tee CH20, and a tee CH21. The inner diameter of each of the straight parts SP20 and SP22 is D20. The inner diameter of the straight part SP21 is D21. The inner diameter D21 is smaller than the inner diameter D20. The tee CH20 is disposed between the straight part SP20 and the straight part SP21. The tee CH21 is disposed between the straight part SP21 and the straight part SP22.

A user inputs a reference position P20, a reference position P21, a reference position P22, and a reference position P23 into the 3D reconstruction device 1a via the user interface included in the input device 2. Actually, the user designates a reference position on a 3D shape indicated by shape information of the subject SB20. Alternatively, the correction-section-setting unit 106 determines the reference position P20, the reference position P21, the reference position P22, and the reference position P23 based on the shape information of the subject SB20.

The correction-section-setting unit 106 sets a correction section CS20, a correction section CS21, and a correction section CS22 based on the reference positions P20 to P23. The correction section CS20 includes a portion of the subject SB20 from the reference position P20 to the reference position P21. The correction section CS21 includes a portion of the subject SB20 from the reference position P21 to the reference position P22. The correction section CS22 includes a portion of the subject 8120 from the reference position P22 to the reference position P23.

After Step S110, the correction coefficient calculation unit 102 sets a target value of the size of the subject in each of the two or more correction sections set by the correction-section-setting unit 106 (Step S111).

A user inputs the target value into the 3D reconstruction device 1a via the user interface included in the input device 2. Alternatively, a target value prepared in advance may be used. For example, the correction coefficient calculation unit 102 determines the type of the subject based on the 3D shape of the subject. A target value is prepared in advance for each type of the subject. The correction coefficient calculation unit 102 uses a target value of the determined type. In the example shown in FIG. 18, the target value of the correction section CS20 and the target value of the correction section CS22 are the same. The target value of the correction section CS21 is different from that of the correction section (S20 and the correction section CS22.

After Step S111, Step S102 is executed. For example, the correction coefficient calculation unit 102 calculates a ratio (St/Si) of a predetermined size St to a size Si at a camera position i in Step S102. The target value of each correction section is used as the size St. The correction coefficient calculation unit 102 calculates a correction coefficient by executing similar processing to that in the first embodiment.

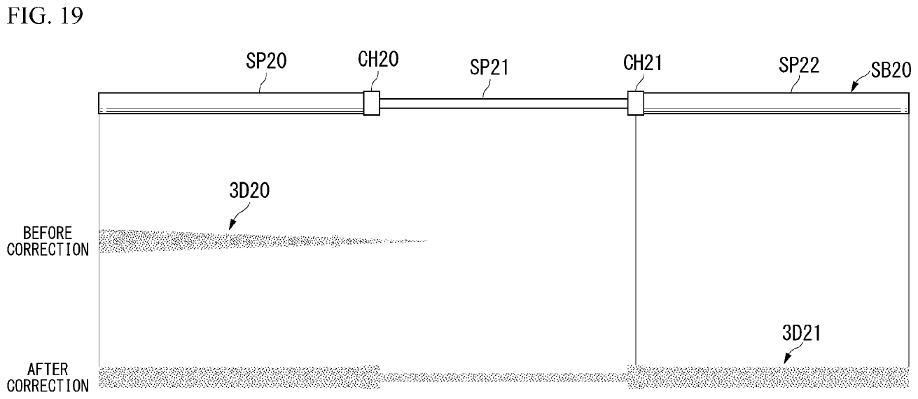

FIG. 19 shows an example of the 3D shape restored by the 3D reconstruction device Ia. A subject SB20 shown in FIG. 19 is the same as that shown in FIG. 18. The camera moves from the left end of the subject SB20 toward the right end of the subject SB20.

A 3D shape 3D20 in FIG. 19 is indicated by the shape information input into the 3D reconstruction device 1a. In other words, the 3D shape 3D20 is restored by using camera positions that have not been corrected by the camera position correction unit 103.

A 3D shape 3D21 in FIG. 19 is indicated by the shape information generated by the 3D shape restoration unit 104. In other words, the 3D shape 3D21 is restored by using camera positions that have been corrected by the camera position correction unit 103.

The 3D shape 3D21 is restored through the processing shown in FIG. 17. The correction coefficient calculation unit 102 calculates a correction coefficient by using the target value set for each correction section as the size St.

The 3D shape 3D20 gradually becomes thinner and shorter from the left side toward the right side. The position of each tee in the 3D shape 3D20 is greatly different from that of each tee in the subject SB20. On the other hand, changes of the length and thickness of the 3D shape 3D21 are considerably restricted.

In the second embodiment, the correction-section-setting unit 106 sets two or more correction sections on a 3D shape of a subject. The correction coefficient calculation unit 102 calculates a correction coefficient for each correction section. The 3D reconstruction device 1a can reduce an error of a 3D shape of a subject including two or more portions having different sizes.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A three-dimensional reconstruction device, comprising a processor configured to:
acquire position-and-orientation information and two-dimensional coordinate information,
wherein the position-and-orientation information indicates two or more different positions of a monocular camera and an orientation of the camera at each of the two or more positions,
wherein the two-dimensional coordinate information indicates two-dimensional coordinates of one or more points in each of two or more images of a subject acquired at the two or more positions by the camera, and
wherein the position-and-orientation information and the two-dimensional coordinate information are generated through three-dimensional reconstruction processing that uses the two or more images;
acquire a three-dimensional size of the subject at each of the two or more positions;
calculate a correction coefficient used for matching the size at each of the two or more positions to a known size;
correct each of the two or more positions by using the correction coefficient; and
restore a three-dimensional shape of the subject by using the two or more corrected positions, the orientation at each of the two or more positions, and the two-dimensional coordinate information.

2. The three-dimensional reconstruction device according to claim 1,
wherein the processor is configured to calculate the three-dimensional size of the subject at each of the two or more positions by using the position-and-orientation information.

3. The three-dimensional reconstruction device according to claim 2,
wherein the processor is configured to:
acquire shape information indicating a three-dimensional shape of the subject; and
calculate, as the size, a depth of the three-dimensional shape indicated by the shape information of the subject captured in a field of view of the camera at each of the two or more positions.

4. The three-dimensional reconstruction device according to claim 2,
wherein the processor is configured to calculate the size based on a distance between two positions included in the two or more positions.

5. The three-dimensional reconstruction device according to claim 2,
wherein the processor is configured to:
acquire shape information indicating a three-dimensional shape of the subject; and
calculate the size by using a predetermined three-dimensional shape that approximates the three-dimensional shape indicated by the shape information.

6. The three-dimensional reconstruction device according to claim 1,
wherein the processor is configured to acquire, from an input device, the size input into the input device.

7. The three-dimensional reconstruction device according to claim 1,
wherein the processor is configured to calculate the correction coefficient by using both the size at each of the two or more positions and a target value of the size.

8. A three-dimensional reconstruction method, comprising:
acquiring, by a processor, position-and-orientation information and two-dimensional coordinate information,
wherein the position-and-orientation information indicates two or more different positions of a monocular camera and an orientation of the camera at each of the two or more positions,
wherein the two-dimensional coordinate information indicates two-dimensional coordinates of one or more points in each of two or more images of a subject acquired at the two or more positions by the camera, and
wherein the position-and-orientation information and the two-dimensional coordinate information are generated through three-dimensional reconstruction processing that uses the two or more images;
acquiring, by the processor, a three-dimensional size of the subject at each of the two or more positions;
calculating, by the processor, a correction coefficient used for matching the size at each of the two or more positions to a known size;
correcting, by the processor, each of the two or more positions by using the correction coefficient; and
restoring, by the processor, a three-dimensional shape of the subject by using the two or more corrected positions, the orientation at each of the two or more positions, and
the two-dimensional coordinate information.

9. A non-transitory computer-readable recording medium saving a program causing a computer to execute:
acquiring position-and-orientation information and two-dimensional coordinate information,
wherein the position-and-orientation information indicates two or more different positions of a monocular camera and an orientation of the camera at each of the two or more positions,
wherein the two-dimensional coordinate information indicates two-dimensional coordinates of one or more points in each of two or more images of a subject acquired at the two or more positions by the camera, and
wherein the position-and-orientation information and the two-dimensional coordinate information are generated through three-dimensional reconstruction processing that uses the two or more images;
acquiring a three-dimensional size of the subject at each of the two or more positions;
calculating a correction coefficient used for matching the size at each of the two or more positions to a known size;
correcting each of the two or more positions by using the correction coefficient; and
restoring a three-dimensional shape of the subject by using the two or more corrected positions, the orientation at each of the two or more positions, and the two-dimensional coordinate information.
